(19) United States
(12) Patent Application Publication
(10) Pub. No.: US 2024/0085937 A1
(43) Pub. Date: Mar. 14, 2024

(54) PROGRAMMABLE OPTICAL COUPLER AND METHODS FOR BEAM ROUTING AND BEAM SHAPING

(71) Applicant: LIGHTSOLVER LTD., Tel Aviv (IL)

(72) Inventors: Harel PRIMACK, Tel Aviv (IL); Talya VAKNIN, Tel Aviv (IL); Chene TRADONSKY, Tel Aviv (IL); Ruti RAN BEN SHLOMI, Tel Aviv (IL)

(73) Assignee: LIGHTSOLVER LTD., Tel Aviv (IL)

(21) Appl. No.: 18/462,419

(22) Filed: Sep. 7, 2023

Related U.S. Application Data
(60) Provisional application No. 63/404,200, filed on Sep. 7, 2022.

(51) Int. Cl. G06E 1/04

(52) U.S. Cl. CPC G06E 1/045

(57) ABSTRACT

The systems and methods disclosed may improve existing optical coupler and sparse coding problem solving technology. Optical coupler technology may be improved by the provision of a versatile, efficient, and rapid optical coupler that may be programmed. Sparse coding optimization technology may be improved by the provision of methods for converting a sparse coding optimization problem into a quadratic unconstrained binary optimization for minimization by an annealer (such as a programmable optical coupler), a quantum computer, or similar apparatus. When combined, the programmable optical coupler may solve sparse coding optimization problems particularly quickly and efficiently.

### CROSS-REFERENCE TO RELATED APPLICATIONS

This application is a continuation-in-part of International Patent Application No. PCT/IL2023/050376, filed Apr. 4, 2023 and also claiming priority from U.S. Provisional Patent Application No. 63/404,200, filed Sep. 7, 2022, both of which are incorporated herein by reference in their entirety.

### FIELD OF THE INVENTION

The present invention relates generally to programmable optical couplers, annealers, and quantum computers, and how to solve a system of linear equations using these apparatuses.

### BACKGROUND OF THE INVENTION

Many problems in the physical world may be represented or modelled with linear algebra. For example, physical systems and problems may be represented by systems of linear equations or linear maps. Systems of linear equations and linear maps may be expressed using matrices.

Thus, there may be a desire in the art for systems and methods that rapidly make predictions or calculations concerning systems that are able to be represented through linear algebra.

There may be a desire in the art for an optical coupler which is programmable and configurable for a variety of operations, including but not limited to linear algebra.

There may be a desire in the art for a means of rapidly and efficiently solving sparse coding optimization problems.

### SUMMARY OF THE INVENTION

Systems and methods of the present invention may improve existing optical coupler and sparse coding problem solving technology. Optical coupler technology may be improved by the provision of a versatile, efficient, and rapid optical coupler (annealer) that may be programmed. Sparse coding optimization technology may be improved by the provision of methods for converting a sparse coding optimization problem into a quadratic unconstrained binary optimization (QUBO) for minimization by an annealer (such as a programmable optical coupler), a quantum computer, or similar apparatus. In combination, the programmable optical coupler may solve sparse coding optimization problems particularly quickly, accurately, and efficiently.

Some embodiments of the present invention include a programmable optical coupler system for solving a sparse coding problem, the programmable optical coupler system comprising: a computing device, the computing device comprising: a processor, the processor configured to: receive a first set of values for a measurement vector and a second set of values for a dictionary matrix, based on an input; convert, using at least one conversion formula, the measurement vector and the dictionary matrix into a quadratic unconstrained binary optimization (QUBO) matrix; a programmable optical coupler, the programmable optical coupler comprising: a light beam source to emit an input array of a plurality of laser beams, wherein each laser beam has a phase and a magnitude; a beam splitter, to split each laser beam of the input array of laser beams, to produce split laser beams; a phase alteration unit to receive values indicative of the QUBO matrix from the computing device, and to alter a phase of each laser beam of the split laser beams based on the QUBO matrix, to produce phase-altered split laser beams; and a beam combiner to combine the phase-altered split laser beams into a combined output array of laser beams, the combined output array of laser beams being substantially perpendicular to the input array of laser beams; a light detector to detect the combined output array of laser beams; and a processor, the processor configured to: minimize light magnitudes of each laser beam of the combined output array of laser beams as measured by the light detector, by altering phase or magnitude of each laser beam of the input array of laser beams, to obtain a minimizing input array of laser beams; and output a phase and magnitude of each laser beam of the minimizing input array of laser beams as a spin vector; wherein the processor of the computing device is further configured to: convert using the at least one conversion formula, the spin vector into a solution vector, wherein the solution vector is indicative of a relationship between the values for a measurement vector and the values for a dictionary matrix.

Some embodiments of the present invention include an annealer or quantum computer system for solving a sparse coding problem, the system comprising: a computing device, the computing device comprising: a processor, the processor configured to: receive a first set of values for a measurement vector and a second set of values for a dictionary matrix, based on an input; convert, using at least one conversion formula, the measurement vector and the dictionary matrix into a quadratic unconstrained binary optimization (QUBO) matrix; an annealer or quantum computer to: receive, from the computing device, the QUBO matrix; and minimize a function of the QUBO matrix and a generalized spin vector, by altering states of the annealer or quantum computer, the states being indicative of values of the generalized spin vector, to obtain a minimizing spin vector; and output the minimizing spin vector; wherein the processor of the computing device is further configured to: convert using the at least one conversion formula, the spin vector into a solution vector, wherein the solution vector is indicative of a relationship between the values for a measurement vector and the values for a dictionary matrix.

Some embodiments of the present invention include a method for solving a sparse coding problem, the method comprising: receiving, by a computing device, a first set of values for a measurement vector and a second set of values for a dictionary matrix, based on a user input; converting, by the computing device, the measurement vector and the dictionary matrix into a quadratic unconstrained binary optimization (QUBO) matrix, using at least one conversion formula; receiving the QUBO matrix at an annealer or quantum computer; minimizing, by the annealer or quantum computer, a function of the QUBO matrix and a generalized spin vector, by altering states of the annealer or quantum computer, the states being indicative of values of the generalized spin vector, to obtain a minimizing spin vector; outputting, by the annealer or quantum computer, the minimizing spin vector; and converting, by the computing device, the spin vector into a solution vector using the at least one conversion formula, wherein the solution vector is indicative of a relationship between the values for a measurement vector and the values for a dictionary matrix.

### BRIEF DESCRIPTION OF THE DRAWINGS

The subject matter regarded as the invention is particularly pointed out and distinctly claimed in the concluding portion of the specification. The invention, however, both as to organization and methods of operation, together with objects, features, and advantages thereof, may best be understood by reference to the following detailed description when read with the accompanying drawings in which:

FIG. 1 shows a basic diagram of a programmable optical coupler according to some embodiments of the present invention;

FIG. 2 shows a basic diagram of a programmable optical coupler according to some embodiments of the present invention;

FIGS. 3A and 3B show example embodiments of a y-axis beam reshaping unit and an x-axis beam reshaping unit, respectively, according to some embodiments of the present invention;

FIG. 4 shows a basic diagram of a programmable optical coupler according to some embodiments of the present invention;

FIG. 5 shows a flowchart of a general method that may be executed on a programmable optical coupler according to some embodiments of the invention;

FIGS. 6-7 show a method for solving a sparse coding problem that may be carried out by a programmable optical coupler system according to some embodiments of the invention.

FIG. 8 shows a method for solving a sparse coding problem according to some embodiments of the invention; and

FIG. 9 shows a block diagram of an exemplary computing device which may be used with embodiments of the present invention.

### DETAILED DESCRIPTION OF THE INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention, including by way of example. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

As used herein, “measurement vector” (usually referred to with the letter b) may refer to a vector that is defined as part of a sparse coding problem. Measurement vector values may, in some embodiments, have been measured, e.g., by a user. In other cases, they are obtained by a sensor. The measurement vector values may include noise or error (e.g., from a measurement). The measurement vector may also be referred to as a “response vector”.

As used herein, “dictionary matrix” (usually referred to with the letter A) may refer to a matrix that is defined as part of a sparse coding problem. The columns of the dictionary matrix may include features, and/or the rows may include observations (or measurements) (e.g., the observations may have been measured by a user). The values of the measurement vector and those of the dictionary matrix may be related; the relationship between measurement vector and dictionary matrix may not be known, but it may be desirable to establish or determine this relationship.

As used herein, “quadratic unconstrained binary optimization problem” or “QUBO problem” (also sometimes referred to as an unconstrained binary quadratic programming (UBQP) problem) may refer to a combinatorial optimization problem known in the art. QUBO problems are used, for example, in signal processing, logistics, transportation, scheduling, finance, drug discovery, genetics, and machine learning.

As used herein, “Quantum Approximate Optimization Algorithm” or “QAOA” are quantum algorithms that may be used to solve optimization problems. Quantum computers may use QAOA to solve QUBO problems. In present invention, it will be understood that, when a quantum computer is to solve a QUBO problem, that it may do so using some form of Quantum Approximate Optimization Algorithms if deemed appropriate.

As used herein, “sparse coding problems” may refer to the problem of how to accurately estimate an unknown sparse vector (the sparse vector may represent a statistical relationship) from a few noisy (or error-prone) measurements. Sparse coding problems may frequently occur in, for example, machine learning, statistics, signal processing, logistics, transportation, scheduling, finance, genetics, and drug discovery.

As used herein, “laser light” or “laser beam” may refer to light emitted through a process of optical amplification based on the stimulated emission of electromagnetic radiation. Alternatively, the skilled person will understand that other light and/or light sources may be used, so long as, for example, the other light and/or light sources have sufficient spatial and/or temporal coherence for the specific implementation at hand. Light in a light beam may be characterized by having a certain magnitude, as well as a certain phase.

As used herein, “magnitude” or “brightness” may refer to the intensity of a light beam, for example, as measured by a light detector.

As used herein, “phase” may refer to a quantity representing the fraction of a wave (e.g., a light wave) cycle that has passed (e.g., at a present point in time). Phases may give rise to known light phenomena, such as interference.

As used herein, “spin” may, in general, refer to a form of angular momentum carried by elementary particles. However, as normally used herein, it refers to a vector that may be encoded, for example, in an annealer or quantum computer (in some annealers and quantum computers, the spin vector may be encoded using the spin of elementary particles). Some spins may be ancilla spins, as may be known in the art.

As used herein, “relationship” may refer to a statistical relationship between datasets. For example, two datasets may be linked by a mathematical function. Datasets may correlate with or depend on one another.

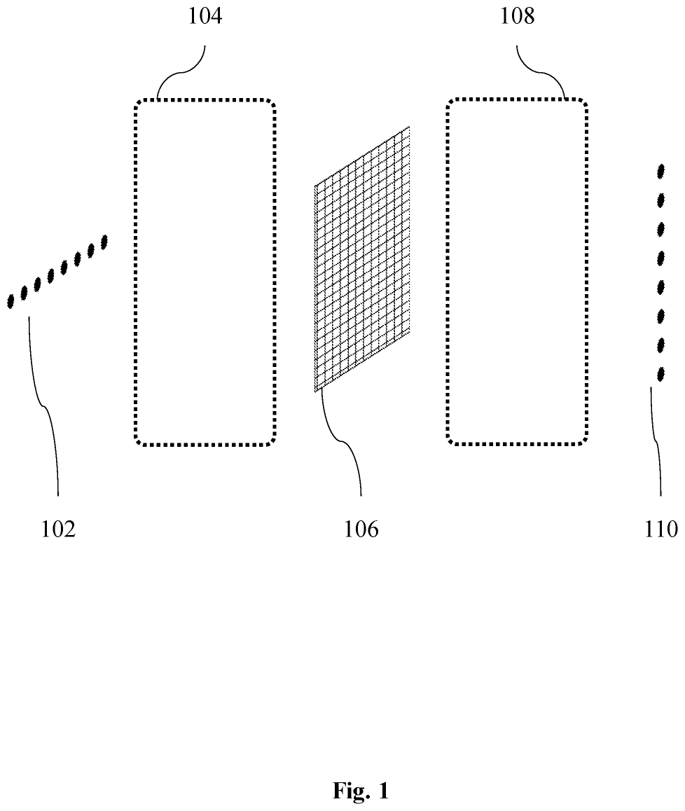

FIG. 1 shows a basic diagram of a programmable optical coupler according to some embodiments of the present invention. The programmable optical coupler of FIG. 1 may be configured to solve vector-matrix multiplication problems quickly and efficiently.

The programmable optical coupler may be configured to receive an array of input light beams 102. The light beams may be produced by one or more light beam emitters (not depicted), such as laser emitters/sources. Each light beam may have a distinct (intensity or amplitude) magnitude, and/or a distinct phase. The magnitude and phase values of each light beam may be in accordance with user-defined distributions for magnitude and phase, and/or may defined or altered by a computer processor (e.g., in some methods of the present invention, magnitude and phase may be altered to minimize detected light magnitude at the other end of the optical coupler). The magnitude and phase values of each light beam may be controlled by the one or more light beam emitters, wherein the light beam emitters may be controllable, such that light beams are emitted with the user- or computer-defined distributions for magnitude and phase. The direction of travel of the light beams during operation of the programmable optical coupler may be through the programmable optical coupler (for example, from the array of input light beams 102 through each component to an array of output light beams 110). The array of input light beams may be arranged along an axis known as an x-axis. It will be appreciated that the exact orientation of the x-axis is arbitrary. For example, the x-axis may be, but need not be, horizontal. The x-axis may be substantially perpendicular to the direction of travel of the input light beams.

The programmable optical coupler may comprise a y-axis beam reshaping unit 104. The y-axis beam reshaping unit may also be known as a y-axis beam splitter. The y-axis beam reshaping unit may be configured to receive the array of input beams. The y-axis beam reshaping unit may be configured to split each light beam of the array of input light beams into a plurality of split beams. Each split beam of the plurality of split beams may be arranged/disposed/stretched along a y-axis, wherein the y-axis may be substantially perpendicular to the x-axis. The y-axis may be substantially perpendicular to the direction of travel of the input light beams. The y-axis reshaping unit may be configured to output a first two-dimensional array of light beams. The first two-dimensional array of light beams may also be known as a first intermediate array of light beams. In some embodiments, the y-axis beam reshaping unit may be configured to apply a phase/intensity change/alteration as represented by matrix A. The y-axis beam reshaping unit may comprise at least one optical element (such as a lens) for dispersing the array of input beams in the y-axis and may comprise at least one optical modulator (such as a spatial light modulator) for causing an interference pattern of the light, in order that a two-dimensional array of light beams may be outputted.

The programmable optical coupler may comprise a phase alteration unit 106. The phase alteration unit may be configured to receive the first two-dimensional array of light beams. The phase alteration unit may be configured to apply a (possibly distinct) phase change/alteration to each light beam of the first two-dimensional array of light beams. Additionally, or alternatively, the phase alteration unit may be configured to apply a (possibly distinct) intensity change/alteration to each light beam of the first two-dimensional array of light beams. The intensity change/alteration may maintain the intensity of a light beam or reduce the intensity of a light beam. In some embodiments, the phase alteration unit may be or may include a spatial light modulator (SLM) and/or a digital micromirror device (DMD). The phase alteration unit may comprise a number of pixels arranged in an xy-plane (plane defined by x-axis and y-axis), wherein each pixel may be configured to apply a phase change and/or a transmission change to light that passes through it. The phase alteration unit may be configured to output a second two-dimensional array of light beams. The second two-dimensional array of light beams may also be known as a second intermediate array of light beams. In some embodiments, the phase alteration unit may be configured to apply a phase alteration, e.g., as represented by matrix W.

The programmable optical coupler may comprise an x-axis beam reshaping unit 108. The x-axis beam reshaping unit may also be known as an x-axis beam combiner. The x-axis beam reshaping unit may be configured to receive the second two-dimensional array of light beams. The x-axis beam reshaping unit may be configured to combine the light beams of each one-dimensional x-axis array of the second two-dimensional array of light beams into a single light beam for each one-dimensional x-axis array, so as to produce an array of output light beams, which may be arranged in the y-axis. Each combined light beam may interfere with at least one other light beam (e.g., constructively interfere or destructively interfere), wherein the interference may be based on the phase and intensity of each light beam. In some embodiments, the x-axis beam reshaping unit may be configured to apply a phase/intensity change/alteration as represented by matrix B. The x-axis beam reshaping unit may comprise at least one optical element (such as a lens) for focussing arrays in the x-axis and may comprise at least one optical modulator (such as a spatial light modulator) for combining an interference pattern of the light, in order that an array of output light beams may be outputted in the y-axis.

The programmable optical coupler may be configured to output an array of output light beams 110, which may be arranged along the y-axis (substantially perpendicular to the array of input light beams). The array of output light beams may be detected, by one or more light detectors (not depicted), such as a camera or a charge-coupled device (CCD). Each light beam may have a distinct (intensity) magnitude, and/or a distinct phase, of which, at least one may be detected by the one or more light detectors.

The programmable optical coupler may further comprise a control unit (not depicted). The control unit may include/comprise/utilise a computing device. The computing device may include a controller or computer processor that may be, for example, a central processing unit processor (CPU), a chip or any suitable computing device; an operating system; a memory; a storage; input devices, which may for example be used to ascertain user-defined distributions; and output devices, such as a computer display or monitor displaying, for example, a computer desktop system. The control unit may be configured to control the optical properties of the components of the programmable optical coupler, for example, in accordance with user-defined distributions, which may in some embodiments also be ascertained by the control unit. For example, the control unit may change the optical properties of the light beam emitters, the y-axis beam reshaping unit, the phase alteration unit, the x-axis beam reshaping unit, or any other components thereof (e.g., spatial light modulators and digital micromirror devices).

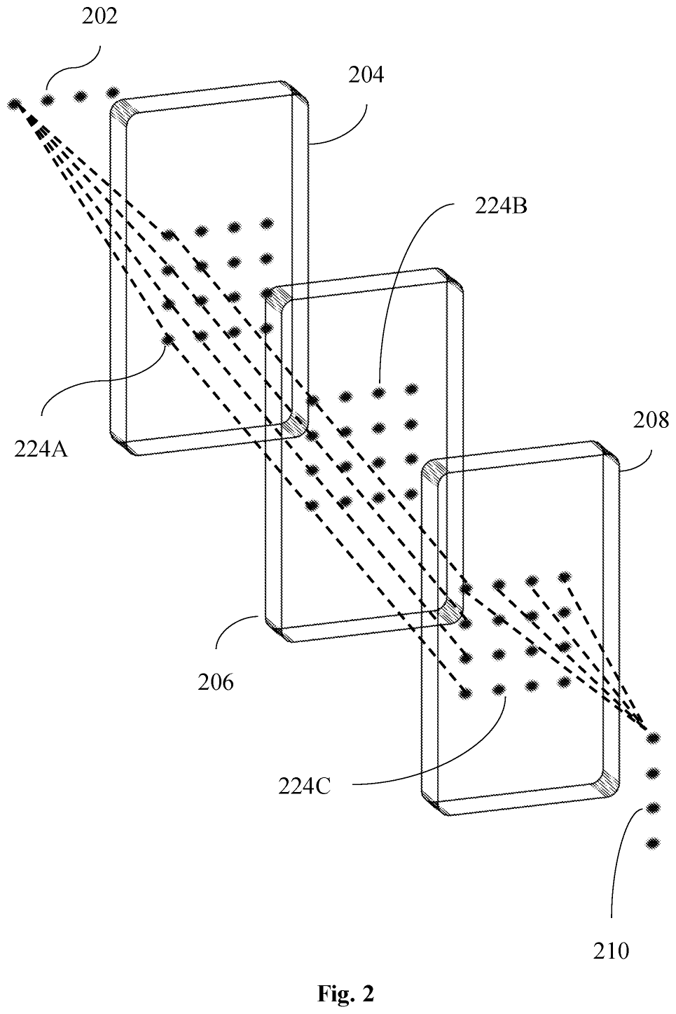

FIG. 2 shows a basic diagram of a programmable optical coupler according to some embodiments of the present invention. The programmable optical coupler of FIG. 2 may be able to solve vector-matrix multiplication or minimization problems quickly and efficiently. FIG. 2 additionally displays a simplified path of some portions of some light beams travelling through the programmable optical coupler.

The programmable optical coupler may be configured to receive an array of input light beams 202. The light beams may be produced by one or more light beam emitters (not depicted). Each light beam may have a distinct (intensity) magnitude, and/or a distinct phase. The array of input light beams may be similar to, or the same as, input light beams 102 of FIG. 1, and the light beam emitters may be similar to, or the same as, the light beam emitters as described in relation to FIG. 1.

The programmable optical coupler may comprise a y-axis beam reshaping unit 204. The y-axis beam reshaping unit may be similar to, or the same as, y-axis reshaping unit 104 of FIG. 1. The y-axis beam reshaping unit may be configured to receive the array of input light beams and output a first two-dimensional array of light beams 224A. The first two-dimensional array of light beams may be arranged in an xy-plane. The first two-dimensional array of light beams may have the same number of beams in the x-axis direction as the array of input light beams 202.

The programmable optical coupler may comprise a phase alteration unit 206. The phase alteration unit may be similar to, or the same as, phase alteration unit 106 of FIG. 1. The phase alteration unit 206 may be configured to receive the first two-dimensional array of light beams 224A and, after a phase and/or intensity change/alteration, output a second two-dimensional array of light beams 224B.

The programmable optical coupler may comprise an x-axis beam reshaping unit 208. The x-axis beam reshaping unit may be similar to, or the same as, x-axis beam reshaping unit 108 of FIG. 1. The x-axis beam reshaping unit 208 may be configured to receive the second two-dimensional array of light beams (which may have propagated some distance along the programmable optical coupler) 224C and output an array of output light beams 210.

The programmable optical coupler may be configured to output the array of output light beams 210, which may be arranged along the y-axis (substantially perpendicular to the array of input light beams). The array of output light beams may be detected, by one or more light detectors (not depicted), such as a camera or a charge-coupled device (CCD). Each light beam may have a distinct (intensity) magnitude, and/or a distinct phase, of which, at least one may be detected by the one or more light detectors. The array of output light beams may be similar to, or the same as, the output light beam 110 of FIG. 1, and the light detectors may be similar to, or the same as, the light detectors as described in relation to FIG. 1. The light detector(s) may be in communication with a computing device or control unit (e.g., to receive information regarding the magnitude, and sometimes phase, of each detected light beam).

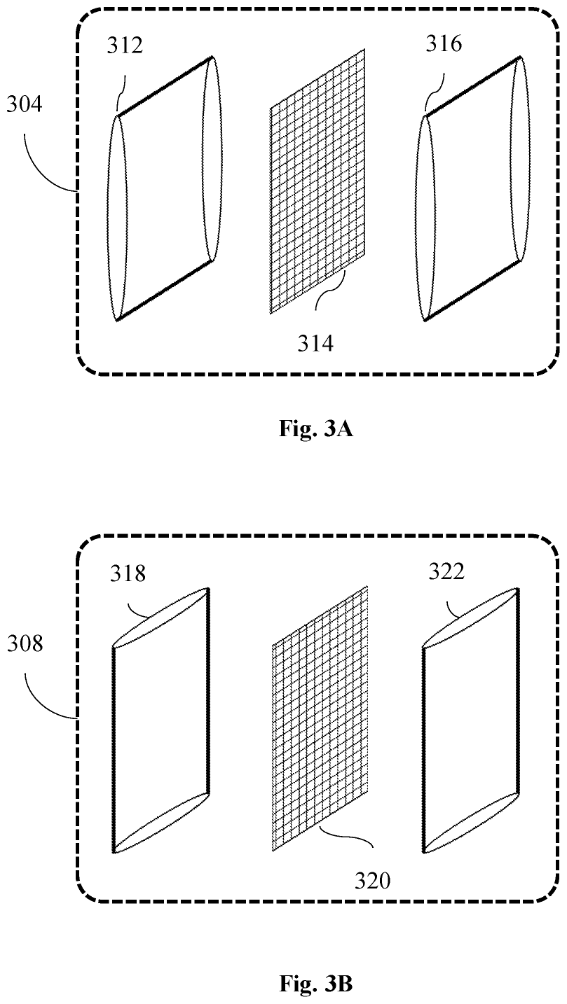

FIG. 3A shows an example embodiment of a y-axis beam reshaping unit 304. The y-axis beam reshaping unit 304 may be used in programmable optical couplers, such as the programmable optical couplers of FIGS. 1 and 2. The y-axis beam reshaping unit may be configured to receive an array of input light beams (possibly arranged along the x-axis) (e.g., 102 and 202) and may be configured to output a first two-dimensional array of light (e.g., 224A).

The y-axis beam reshaping unit 304 may comprise a first y-axis optical element 312. The first y-axis optical element may be configured to receive the array of input light beams and may disperse each light beam of the array of input light beams in the y-axis direction. The first y-axis optical element may be configured to neither substantially focus nor substantially disperse the shape of the array of input light beams in the x-axis direction. The first y-axis optical element may be/comprise a cylindrical (or substantially cylindrical) lens, wherein a cylinder axis coincides with the x-axis. The first y-axis optical element may be/comprise a convex lens or a concave lens.

The y-axis beam reshaping unit 304 may comprise a y-axis light modulator 314. The y-axis light modulator may be configured to apply a (possibly distinct) phase change/alteration to input light. Additionally, or alternatively, the y-axis light modulator may be configured to apply a (possibly distinct) intensity change/alteration to input light. The intensity change/alteration may maintain the intensity of the input light or reduce the intensity of the input light. In some embodiments, the y-axis light modulator may be or may include a spatial light modulator (SLM) and/or a digital micromirror device (DMD). The y-axis light modulator may comprise a number of pixels arranged in an xy-plane (plane defined by x-axis and y-axis), wherein each pixel may be configured to apply a phase change and/or a transmission change to light that passes through it. The phase and intensity changes of the y-axis light modulator may correspond to values of a matrix. The y-axis light modulator may be configured to apply a phase and/or intensity mask/pattern to the incoming light, in order that the light splits into a required number of light beams. The mask/pattern may be defined by a Fourier transform of a function which describes a pattern required at the phase alteration unit.

The y-axis beam reshaping unit 304 may comprise a second y-axis optical element 316. The second y-axis optical element may be configured to output the first two-dimensional array of light beams. The second y-axis optical element may focus each input light beam in the y-axis. The second y-axis optical element may be configured to neither substantially focus nor substantially disperse the shape of input light in the x-axis. The second y-axis optical element may comprise a cylindrical (or substantially cylindrical) lens, wherein a cylinder axis coincides with the x-axis. The second y-axis optical element may be/comprise a convex lens. The second y-axis optical element may be configured to converge the light beams into a substantially parallel configuration.

FIG. 3B shows an example embodiment of an x-axis beam reshaping unit 308. The x-axis beam reshaping unit 308 may be used in programmable optical couplers, such as the programmable optical couplers of FIGS. 1 and 2. The x-axis beam reshaping unit may be configured to receive a second two-dimensional array of light beams (e.g., 224C) and may be configured to output an array of output light beams (possibly arranged along the y-axis) (e.g., 224A).

The x-axis beam reshaping unit 308 may comprise a first x-axis optical element 318. The x-axis optical element may be configured to receive the second two-dimensional array of light beams and may focus each light beam of the second two-dimensional array of light beams in the x-axis. The first x-axis optical element may be configured to neither substantially focus nor substantially disperse the shape of input light in the y-axis. The first x-axis optical element may comprise a cylindrical (or substantially cylindrical) lens, wherein a cylinder axis coincides with the y-axis. The first x-axis optical element may be/comprise a convex lens.

The x-axis beam reshaping unit 308 may comprise an x-axis light modulator 320. The x-axis light modulator may be configured to apply a (possibly distinct) phase change/alteration to input light. Additionally, or alternatively, the x-axis light modulator may be configured to apply a (possibly distinct) intensity change/alteration to input light. The intensity change/alteration may maintain the intensity of the input light or reduce the intensity of the input light. In some embodiments, the x-axis light modulator may be or may include a spatial light modulator (SLM) and/or a digital micromirror device (DMD). The x-axis light modulator may comprise a number of pixels arranged in an xy-plane (plane defined by x-axis and y-axis), wherein each pixel may be configured to apply a phase change and/or a transmission change to light that passes through it. The phase and intensity changes of the x-axis light modulator may correspond to values of a matrix. The x-axis light modulator may be configured to apply a phase and/or intensity mask/pattern to the incoming light, in order that the light combines into one light beam (for each array along an x-axis). The mask/pattern may be defined by a Fourier transform of a function which describes a pattern required at the output.

The x-axis beam reshaping unit 308 may comprise a second x-axis optical element 322. The second x-axis optical element may be configured to output the array of output light beams. The second x-axis optical element may focus each input light beam in the x-axis. The second x-axis optical element may be configured to neither substantially focus nor substantially disperse the shape of input light in the y-axis. The second x-axis optical element may comprise a cylindrical (or substantially cylindrical) lens, wherein a cylinder axis coincides with the y-axis. The second y-axis optical element may be/comprise a convex lens or a concave lens.

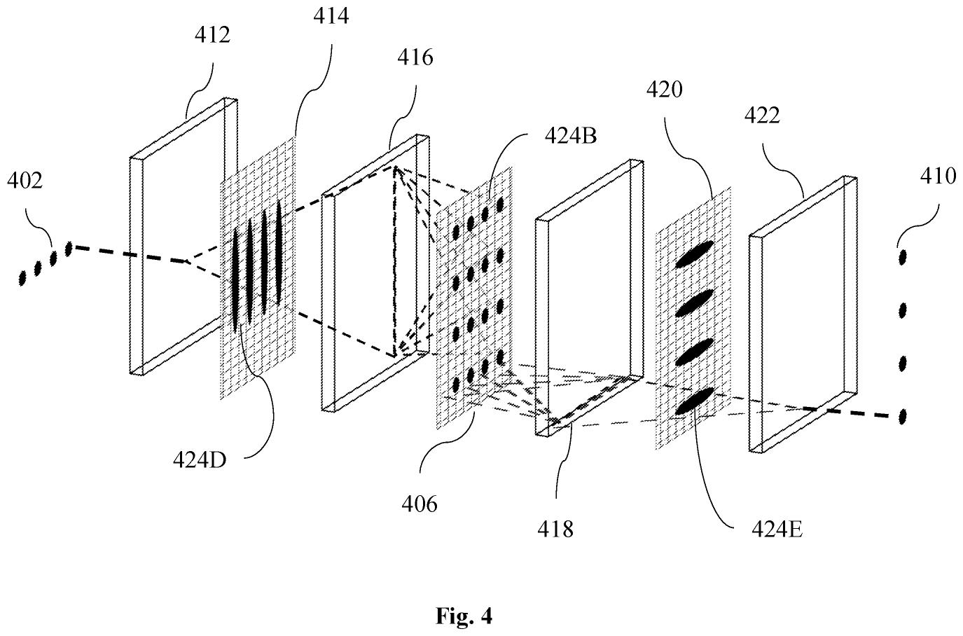

FIG. 4 shows a basic diagram of a programmable optical coupler according to some embodiments of the present invention. The programmable optical coupler of FIG. 4 may be configured to solve vector-matrix multiplication problems quickly and efficiently. FIG. 4 additionally displays a simplified path of light beams travelling through the programmable optical coupler.

The programmable optical coupler may be configured to receive an array of input light beams 402. The light beams may be produced by one or more light beam emitters (not depicted). Each light beam may have a distinct (intensity) magnitude, and/or a distinct phase. The array of input light beams may be similar to, or the same as, input light beams 102 of FIG. 1 and 202 of FIG. 2, and the light beam emitters may be similar to, or the same as, the light beam emitters as described in relation to FIG. 1 and FIG. 2. The array of input light beams may each have a magnitude and phase of the light. The magnitude and phase of the light of each light beam may be controlled (e.g., by the light beam emitters and the control unit), such that they correspond to the respective magnitude and phase of elements of an input vector (e.g. q), which may be user- or computer-defined. For example, a matrix may have a first element with a magnitude of 5 (in arbitrary units) and a phase of π/2 and a second element of magnitude 10 (in arbitrary units) and a phase of 3π/2. The array of input light beams may have a corresponding first beam, and a corresponding second beam, wherein the second beam may have a magnitude twice that of the first beam (possibly corresponding to a light intensity four times higher, or possibly two times higher (depending on the definition of the magnitude that is intended)) and the second beam may have a phase difference of w compared to the first beam.

The programmable optical coupler may comprise a first y-axis optical element 412. The first y-axis optical element may be configured to receive the array of input light beams and may disperse each light beam of the array of input light beams in the y-axis direction. The first y-axis optical element may be configured to neither substantially focus nor substantially disperse the shape of the array of input light beams in the x-axis direction. The first y-axis optical element may comprise a cylindrical (or substantially cylindrical) lens, wherein a cylinder axis coincides with the x-axis. The first y-axis optical element may be similar to, or the same as, the first y-axis optical element 312 of FIG. 3A.

The programmable optical coupler may comprise a y-axis light modulator 414. The y-axis light modulator may be or may include a spatial light modulator (SLM) and/or a digital micromirror device (DMD). The y-axis light modulator may be similar to, or the same as, the y-axis light modulator 314 of FIG. 3A. A first array of stretched light beams 424D may be incident on the y-axis light modulator.

The programmable optical coupler may comprise a second y-axis optical element 416. The second y-axis optical element may be configured to output the first two-dimensional array of light beams. The second y-axis optical element may focus each input light beam in the y-axis. The second y-axis optical element may be configured to neither substantially focus nor substantially disperse the shape of input light in the x-axis direction. The second y-axis optical element may comprise a cylindrical (or substantially cylindrical) lens, wherein a cylinder axis coincides with the x-axis. The second y-axis optical element may be similar to, or the same as, the second y-axis optical element 316 of FIG. 3A.

The programmable optical coupler may comprise a phase alteration unit 406. The phase alteration unit may be similar to, or the same as, phase alteration unit 106 of FIG. 1 or 206 of FIG. 2. The phase alteration unit 406 may be configured to receive a first two-dimensional array of light beams (e.g. 424A) and, after a phase and/or intensity change/alteration, output a second two-dimensional array of light beams 424B. The phase alteration unit may perform an intensity and/or phase change on the incoming light beams that may be in accordance with matrix W (e.g., each beam of the first two-dimensional array of beams may be incident on a pixel of the phase alteration unit that performs the operation of the matrix W at the corresponding position).

The programmable optical coupler may comprise a first x-axis optical element 418. The x-axis optical element may be configured to receive a second two-dimensional array of light beams 424B and may focus each light beam of the second two-dimensional array of light beams in the x-axis, while neither substantially focussing nor substantially dispersing the shape of input light in the y-axis. The first x-axis optical element may comprise a cylindrical (or substantially cylindrical) lens, wherein a cylinder axis coincides with the y-axis. The first x-axis optical element may be similar to, or be the same as, the first x-axis optical element 318 of FIG. 3B.

The programmable optical coupler may comprise an x-axis light modulator 420. The x-axis light modulator may be or may include a spatial light modulator (SLM) and/or a digital micromirror device (DMD). The x-axis light modulator may be similar to, or be the same as, the x-axis light modulator 320 of FIG. 3B. A second array of stretched light beams 424E may be incident on the x-axis light modulator.

The programmable optical coupler may comprise a second x-axis optical element 422. The second x-axis optical element may be configured to output the array of output light beams. The second x-axis optical element may focus each input light beam in the x-axis, while neither substantially focussing nor substantially dispersing the shape of input light in the y-axis. The second x-axis optical element may comprise a cylindrical (or substantially cylindrical) lens, wherein a cylinder axis coincides with the y-axis. The second x-axis optical element may be similar to, or be the same as, the second x-axis optical element 322 of FIG. 3B.

The programmable optical coupler may be configured to output the array of output light beams 410, which may be arranged along the y-axis (substantially perpendicular to the array of input light beams). The array of output light beams may be detected, by one or more light detectors (not depicted), such as a camera or a charge-coupled device (CCD). Each light beam may have a distinct (intensity) magnitude, and/or a distinct phase, of which, at least one may be detected by the one or more light detectors. The array of output light beams may be similar to, or the same as, output light beams 102 of FIG. 1 and 202 of FIG. 2. The magnitude and phase of the light of each light beam may correspond to the respective magnitude and phase of elements of an output vector, which may be the result of a multiplication, for example, q^{T}Wq.

For example, an output vector may have a first element with a magnitude of 6 and a phase of 0 and a second element of magnitude 9 and a phase of π/2. The array of output light beams may have a corresponding first beam, and a corresponding second beam, wherein the second beam may have a magnitude 1.5 times that of the first beam (possibly corresponding to a light intensity 2.25 times higher) and the second beam may have a phase difference of π/2 compared to the first beam.

In some embodiments, the one or more light detectors, such as a camera or CCD, may be able to detect an intensity of the light incident on the light detector (which may be proportional to the square of the magnitude of the light), but may be unable to detect a phase of the light incident on the light detector. For example, many cameras are unable to detect a light phase. In some embodiments, a phase retrieval algorithm may be used to calculate the phase of the incident light, if required.

Some embodiments of the present invention may comprise a method for performing vector-matrix multiplication (such as the vector-matrix multiplication described above) using a programmable optical coupler.

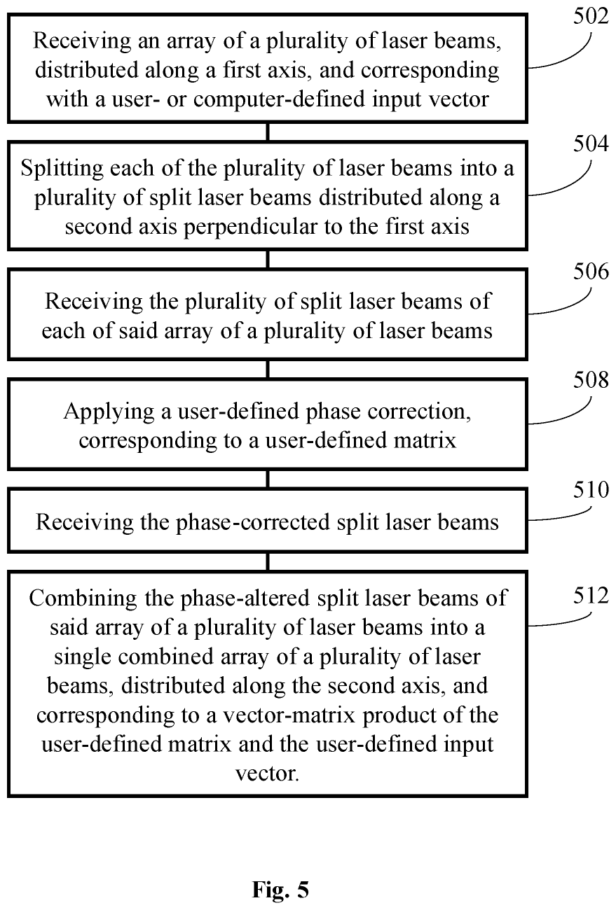

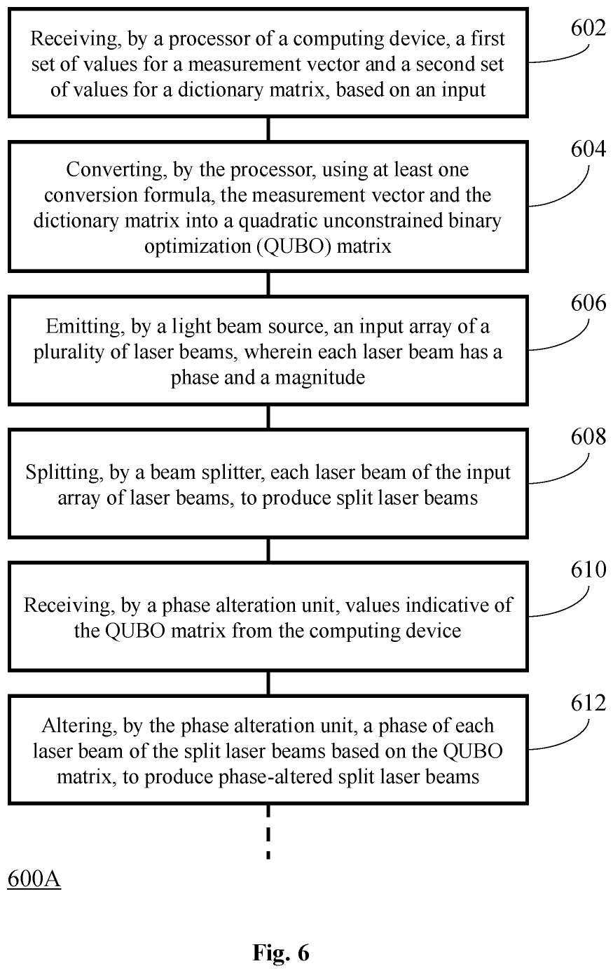

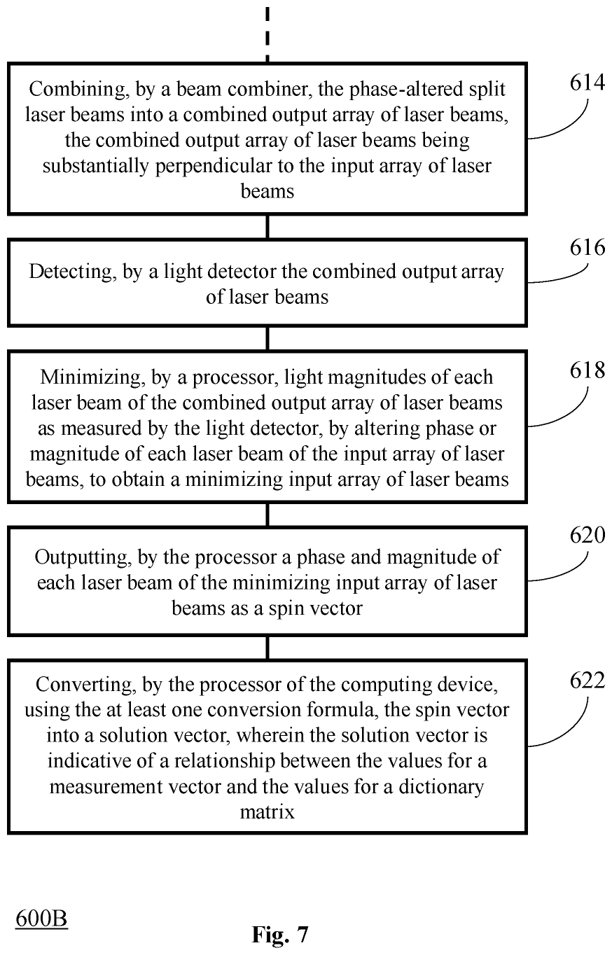

FIG. 5 shows a flowchart of a general method that may be executed on a programmable optical coupler according to some embodiments of the invention. The method may be performed by a programmable optical coupler according to embodiments of the invention. The method of FIG. 5 may be a general method in which the programmable optical coupler may be used in general circumstances (methods for using the programmable optical coupler for solving sparse coding problems are also disclosed herein, e.g., see FIGS. 6-7).

In step 502, a beam splitter may receive an array of a plurality of laser beams distributed along a first axis, wherein the array of a plurality of laser beams distributed along a first axis may correspond with a user- or computer-defined input vector.

In step 504, a beam splitter may split each of the plurality of laser beams into a plurality of split laser beams distributed along a second axis, wherein the first axis may be substantially perpendicular to the second axis. The beam splitter of step 504 may also be the beam splitter of step 502.

In step 506, a phase alteration unit may receive the plurality of split laser beams of each of said array of a plurality of laser beams.

In step 508, a phase alteration unit may apply a user- or computer-defined phase alteration, wherein the user- or computer-defined phase alteration may correspond to a user- or computer-defined matrix. The phase alteration unit of step 508 may also be the phase alteration unit of step 506.

In step 510, a beam combiner may receive the phase-altered split laser beams.

In step 512, a beam combiner may combine the phase-altered split laser beams of said array of a plurality of laser beams into a single combined array of a plurality of laser beams distributed along the second axis, wherein the single combined array of a plurality of laser beams distributed along the second axis may correspond to a vector-matrix product involving the user- or computer-defined matrix and the user- or computer-defined input vector (e.g., q^{T}Wq, where q is input vector and W is the matrix, and q^{T} is the transpose of q). The beam combiner of step 512 may also be the beam combiner of step 510.

A problem that may be solved with a programmable optical coupler, for example, the programmable optical coupler described with respect to FIGS. 1-5, is quadratic unconstrained binary optimization (QUBO) problem (also sometimes referred to as an unconstrained binary quadratic programming (UBQP) problem). QUBO is a problem in multitude fields including the field of combinatorics and is generally classified, but not limited to, as NP, NP-complete or NP hard.

Additional apparatuses and machines, as may be known in the art, may also be able to solve QUBO problems, for example, quantum computers, annealers, optical annealers, annealers that are based (in part or in full) on non-optical principles, and Ising machines. In addition, heuristics may be run on classical computers (e.g., as described herein) in order to solve QUBO problems, for example, simulated annealing and Tabu search. A programmable optical coupler is a type of annealer, however other types of annealers may also be used to solve QUBO problems. A programmable optical coupler may be a type of optical annealer.

A quadratic unconstrained binary optimization (QUBO) problem may be defined mathematically as follows:

$${q}^{⊤} Wq , \qquad EQN . 1$$

where [symbol] represents a set of binary numbers, q (as defined above), is a (possibly binary) matrix of size D, and W is a D×D real-valued matrix, called a QUBO matrix.

A programmable optical coupler may be used to solve a QUBO problem by, for example, executing some or all of the operations of FIGS. 6-7.

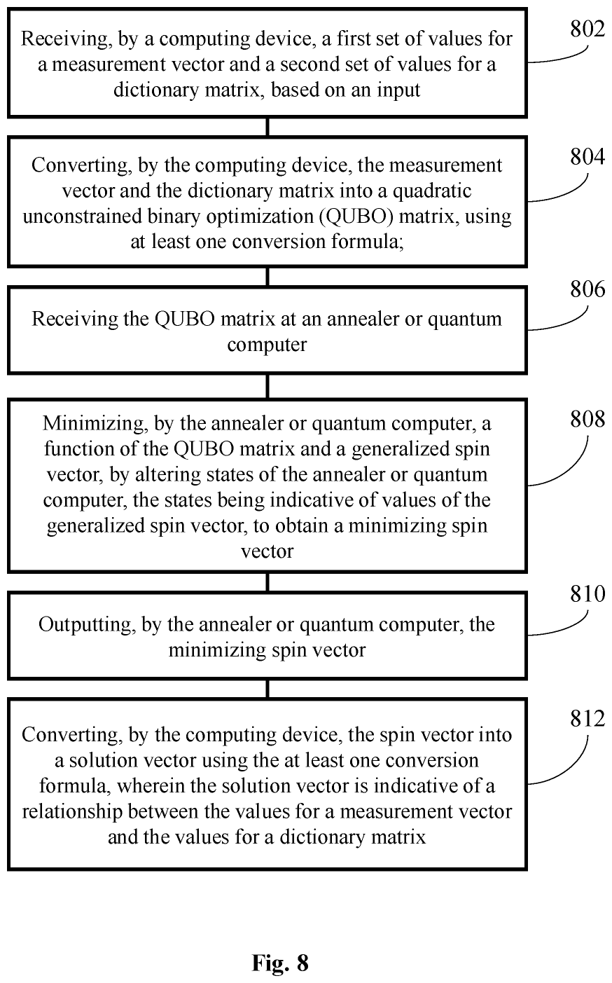

Quantum computers and annealers (as well as other suitable devices) may be used to solve a QUBO problem by, for example, executing some or all of the operations of FIG. 8.

Apparatuses, such as the programmable optical coupler, quantum computers and Ising machines may solve QUBO problems quickly, accurately and/or efficiently.

Therefore, it may be beneficial to define problems (e.g., other problems) as QUBO problems. It may not always be obvious how to achieve this.

A sparse coding optimization problem may be defined as follows:

We may be given a linear system of equations:

Ax=b, EQN. 2

where A is an M×N matrix, x is an N column vector of variables/coefficients, and b is an M column vector of samples/measurements. The system can be determined (M=N), underdetermined (M<N) or overdetermined (M>N). We may seek a vector x of length N that minimizes the L₂-norm of the error:

r_{L}_{₂}=∥Ax−b∥₂². EQN. 3

In the case of determined or underdetermined system, the system can be solved in general, and r_{L}_{₂} will be zero, the global minimum of the system. In the case of an overdetermined system, the minimum of r_{L}_{₂} represents the least-mean-square solution of the system. Thus, minimizing r_{L}_{₂} regarded henceforth as solving the system for all cases.

In general, in the underdetermined case (but not limited to the underdetermined case), there exist (infinitely-) many solutions to the system, and often we seek the solution with the minimal number of non-zero components (minimal support). This action of looking for a solution with minimal support is denoted as “sparsity” or “L₀ regularization”. In mathematical terms, we are looking for a solution x of the linear system that also minimizes the following expression:

$${r}_{{L}_{0}} = {\sum }_{i = 1}^{N} ( {x}_{i} \neq 0 ) , \qquad EQN . 4$$

where L₀ is denoted the “cardinality” of x and

$$( {x}_{i} \neq 0 ) = \{ \begin{matrix}0 & {x}_{i} = 0 \\ 1 & {x}_{i} \neq 0\end{matrix} . \qquad EQN . 5$$

In other words, we are looking for a vector x that satisfies

$$\begin{matrix}{min}_{x} {r}_{{L}_{0}} & s . t . & {r}_{{L}_{2}} = 0.\end{matrix} \qquad EQN . 6$$

According to the Lagrange multiplier method, we can rewrite the above expression as

$${min}_{x , λ} H = {min}_{x , λ} ( {r}_{{L}_{2}} + λ {r}_{{L}_{0}} ) . \qquad EQN . 7$$

For λ=0 we solve only the original system with no sparsity imposed, for λ→∞ all xᵢ are zero regardless of the system, and for intermediate values of λ we tune between the error of the linear system and sparsity. For the exact case (no noise) λ→0⁺ gives the exact sparse solution. When we have noise or when the system is not underdetermined, finite values of balance between the linear system error and the sparsity. The expression (rewritten according to the Lagrange multiplier method) above should now be transformed into QUBO form.

We may start with a simple case, in which we “quantize” each xᵢ, that is, we restrict it to a pre-defined set of discrete values, as follows:

$$\begin{matrix}{x}_{i} = {Δ}_{i} {\sum }_{k = 1}^{K} k {x}_{i k} , & {x}_{i k} ∈ \{ 0 , 1 \} , & i = 1 , … , N\end{matrix} , \qquad EQN . 8$$

where each xᵢₖ is a “spin” or “qubit”, which obtain the values of 0 and 1 only. Each i is allowed to have at most a single xᵢₖ=1, and the other xᵢₖ's are 0. This is the basis for the QUBO formulation. We need to show that we can re-write H from the Lagrange multiplier expression using only linear and bilinear expressions in the variables xᵢₖ. It should be noted, that the above expression for xᵢ, which can be denoted as “equispaced unary representation”, is only exemplary, and many other such discrete representation of xᵢ are possible, including, but not limited to non-equispaced representations and binary representations. In fact, for any given set of values V=v₁, v₂, . . . , v_{K}, it can be easily shown that a unary representation of xᵢ containing the values in V exists using the spins xᵢₖ. It should also be noted that the above expression for xᵢ includes 0 as one of the possible values of xᵢ.

We can construct the QUBO expression as follows:

H=aH₁+bH₂+cH₃,a,b,c>0, EQN. 9

wherein minimizing H over the spins xᵢₖ gives the solution to xᵢ, as required.

H₁ is a hard constraint for the validity of the unitary representation of xᵢ. As noted above, for the unary expression of xᵢ to be valid, we need to make sure that for each i there is at most a single xᵢₖ which is 1, and others are 0. This is achieved by stating the following expression to minimize:

$${H}_{1} = {\sum }_{i = 1}^{N} [ {( {\sum }_{k = 1}^{K} {x}_{i k} )}^{2} - ( {\sum }_{k = 1}^{K} {x}_{i k} ) ] = 2 {\sum }_{i = 1}^{N} {\sum }_{{k}_{1} \neq {k}_{2} = 1}^{K} {x}_{i {k}_{1}} {x}_{i {k}_{2}} . \qquad EQN . 10$$

It can be shown, that for each i, the inner k-summation in this expression for H₁, is 0 if and only if there is 0 or 1 xᵢₖ's that are 1, and the others are 0—which is the case for a valid unary representation of xᵢ. In any other case, the inner k-summation is positive. Hence, H₁=0 if and only if xᵢₖ form a valid unary representation of all xᵢ. H₁ can be written in terms of matrix multiplication:

H₁=x·W·x, EQN. 11

with x a vector of size NK and matrix W of size NK×NK which takes the block form

$$( \begin{matrix}0 & 2 & … & 2 & & 0 & … & 0 & 0 \\ 2 & 0 & … & 2 & … & ⋱ & & & ⋮ \\ ⋮ & ⋮ & ⋱ & ⋮ & & & ⋱ & & 0 \\ 2 & 2 & … & 0 & & 0 & … & 0 & 0 \\ & & ⋮ & & ⋱ & & & ⋮ & \\ 0 & … & 0 & 0 & & 0 & 2 & … & 2 \\ ⋱ & & & ⋮ & … & ⋮ & 0 & … & ⋮ \\ & ⋱ & & 0 & & 2 & 2 & ⋱ & 2 \\ 0 & … & 0 & 0 & & 2 & 2 & … & 0\end{matrix} ) . \qquad EQN . 12$$

H₂ is a cost function that minimizes the error of the linear system r_{L}_{₂}. We substitute (6) into (2) to obtain the bilinear form:

$$\begin{matrix}{H}_{2} = {\sum }_{i = 1}^{M} {( {\sum }_{j = 1}^{N} {A}_{ij} {x}_{j} - {b}_{i} )}^{2} \\ = {\sum }_{i = 1}^{M} {( {\sum }_{j = 1}^{N} {A}_{ij} ( {Δ}_{j} {\sum }_{k = 1}^{K} {kx}_{jk} ) - {b}_{i} )}^{2} \\ = {\sum }_{j = 1}^{N} {\sum }_{{j}^{′} = 1}^{N} {\sum }_{k = 1}^{K} {\sum }_{{k}^{′} = 1}^{K} {x}_{jk} {x}_{{j}^{′} {k}^{′}} {U}_{jk , {j}^{′} {k}^{′}}^{1} + {\sum }_{j = 1}^{N} {\sum }_{k = 1}^{K} {x}_{jk} {U}_{jk , jk}^{2} + {h}^{U}\end{matrix} , \qquad EQN . 13$$

where the explicit expressions for the matrices are given by

$${U}_{j k , {j}^{′} {k}^{′}}^{1} := {\sum }_{i = 1}^{M} {A}_{i j} {A}_{i {j}^{′}} {Δ}_{j} {Δ}_{{j}^{′}} {kk}^{′} , \qquad EQN . 14$$

$${U}_{j k , j k}^{2} := - 2 {\sum }_{i = 1}^{M} {A}_{i j} {Δ}_{j} k {b}_{i} , \qquad EQN . 15$$

$${h}^{U} := {\sum }_{i = 1}^{M} {b}_{i}^{2} . \qquad EQN . 16$$

H₃ is a cost function that minimizes the cardinality r_{L}_{₀}: We formulate the cardinality r_{L}_{₀} of x, as defined herein, using the unary representation of xᵢ, as follows:

$${H}_{3} = {\sum }_{i = 1}^{N} ( {\sum }_{k = 1}^{K} {x}_{i k} ) , \qquad EQN . 17$$

which, in terms of NK×NK matrix as discussed above, is nothing but an identity matrix. We note, that for the inner k-summation in this equation for H₃, and due to the restrictions on the spins xᵢₖ found with respect to H₁, we have the following:

$${\sum }_{k = 1}^{K} {x}_{i k} = \{ \begin{matrix}0 , & {x}_{i} = 0 \\ 1 , & {x}_{i} \neq 0\end{matrix} . \qquad EQN . 18$$

Therefore, in summary, the above expressions form QUBO expressions/formulations of a sparse coding optimization problem for the case in which the variables xᵢ are represented in unary representations using the spins xᵢₖ.

Another exemplary case is the same as above, except that we want a to impose a specific sparsity (cardinality) that is exactly s non-zero xᵢ's. In that case we need to modify H₃ to the following expression:

$${H}_{3} ( s ) = {( {\sum }_{i = 1}^{N} ( {\sum }_{k = 1}^{K} {x}_{i k} ) - s )}^{2} . \qquad EQN . 19$$

As seen, H₃(s) contains only linear and bilinear expressions in the spins xᵢₖ, and hence constitutes a valid QUBO expression. For other cases of unary representation, like, for example when first defining xᵢ, adding a constant to xᵢ or defining non-evenly distributed values of xᵢ, one would need to modify H₃. This is straightforward, and we shall not discuss it here explicitly.

Unary representation can be wasteful, since it is linear in the desired resolution of the solution. However, it is quite straightforward to handle as a QUBO model. Binary representation is much more compact, only log₂ R of the desired resolution R. It's implementation in terms of a QUBO model takes the following form:

$$( {H}_{{L}_{2}} + λ {H}_{{L}_{0}} ) = {q}^{⊤} ( {W}^{{L}_{2}} + λ {W}^{{L}_{0}} ) q . \qquad EQN . 20$$

where q is a binary vector of spins. These spins express the unknown elements in the vector x, using fixed-point arithmetic as follows:

$$\begin{matrix}{x}_{i} = {c}_{i}^{min} + {d}_{i} {\sum }_{p = 1}^{P} {q}_{i , p} {2}^{p - 1} , & P \geq 1.\end{matrix} \qquad EQN . 21$$

wherein cᵢ^{min}, dᵢ, and P are pre-specified constants. Constant cᵢ^{min} is the minimal value that can be expressed, dᵢ is a scaling factor, and P is the number of bits allocated. The variables:

q_{i,p}ϵ [symbol] ,1≤i≤N,1≤p≤P, EQN. 22

are the spins, stored in the NP dimensional vector

q=[q_{1,1}, . . . ,q_{1,P},q_{2,1}, . . . ,q_{2,P}, . . . ,q_{N,1}, . . . ,q_{N,P}]^{T}. EQN. 23

The above is the most general representation for x using binary representation. Importantly, we require that the value 0 is always contained in the possible values that xᵢ can take; otherwise, this variable/feature would always be considered a non-zero.

In the following section. we show how to formulate the squared term error from the L₂ norm of the error as a QUBO problem that minimizes the same objective, however, with respect to the spins q. To do so, we first expand the L₂ norm and rewrite it as follows:

$${H}_{{L}_{2}} := {‖ Ax - b ‖}_{2}^{2} = {\sum }_{i = 1}^{N} {\sum }_{j = 1}^{N} {x}_{i} {x}_{j} {W}_{i , j}^{base , 1} + {\sum }_{i = 1}^{N} {x}_{i} {W}_{i , i}^{base , 2} + {h}^{base} , \qquad EQN . 24$$

where W^{base,1} is a matrix of size N×N with entries

$$\begin{matrix}{W}_{i , j}^{b a s e , 1} := {\sum }_{m = 1}^{M} {A}_{m , i} {A}_{m , j} & 1 \leq i , j \leq N\end{matrix} , \qquad EQN . 25$$

the diagonal matrix W^{base,2} is also of size N×N with diagonal elements

$$\begin{matrix}{W}_{i , i}^{b a se , 2} := - 2 {\sum }_{m = 1}^{M} {A}_{m , i} {b}_{m} , & 1 \leq i \leq N ,\end{matrix} \qquad EQN . 26$$

and h^{base} is a constant scalar, defined as

$${h}^{b a s e} := {\sum }_{m = 1}^{M} {b}_{m}^{2} . \qquad EQN . 27$$

Next, we plug into the expression for H_{L}_{₂}, the explicit fixed-point expression for xᵢ defined above, and thus expressing H_{L}_{₂} using the binary spins q_{i,p}ϵ [symbol] in lieu of xᵢ. After applying basic algebraic manipulations, we get the following expression:

$${H}_{{L}_{2}} := {\sum }_{i = 1}^{N} {\sum }_{j = 1}^{N} {\sum }_{s = 1}^{P} {\sum }_{p = 1}^{P} {q}_{i , s} {q}_{j , p} {W}_{s + P ( i - 1 ) , p + P ( j - 1 )}^{{L}_{2} , 1} + {\sum }_{i = 1}^{N} {\sum }_{p = 1}^{P} {q}_{i , p} {W}_{p + P ( i - 1 ) , p + P ( i - 1 )}^{{L}_{2} , 1} + {h}^{{L}_{2}} , \qquad EQN . 28$$

where W^{L}^{₂}^{,1} is a matrix of size NP×NP whose entries are given by

W_{s+P(i-1),p+P(j-1)}^{L}^{₂}^{,1}:=2^{s+p-2}W_{i,j}^{base,1}dᵢdⱼ,1≤i,j≤N,1≤s,p≤P, EQN. 29

additionally, W^{L}^{₂}^{,2} is a diagonal matrix whose diagonal elements are expressed as

$$\begin{matrix}{W}_{p + P ( i - 1 ) , p + P ( i - 1 )}^{{L}_{2} , 2} := {2}^{p - 1} {d}_{i} ( {W}_{i , i}^{b ase , 2} + 2 {\sum }_{j = 1}^{N} {c}_{j}^{min} {W}_{i , j}^{b ase , 1} ) , & \end{matrix} \qquad EQN . 30$$

$$1 \leq i \leq N , 1 \leq p \leq P ,$$

and the constant h^{L}^{₂} is formulated as

$${h}^{{L}_{2}} = {\sum }_{i = 1}^{N} {\sum }_{j = 1}^{N} {W}_{i , j}^{base , 1} {c}_{i}^{min} {c}_{j}^{min} + {\sum }_{i = 1}^{N} {W}_{i , i}^{base , 2} {c}_{i}^{min} + {h}^{base} . \qquad EQN . 31$$

We may make two observations based on the above. Firstly, since q_{i,p} is binary we have q_{i,p}q_{i,p}=q_{i,p}²=q_{i,p}, and therefore we can add the diagonal elements of W_{ip,ip}^{L}^{₂}^{,1} to those of W_{ip,ip}^{L}^{₂}^{,2}. Secondly, the minimization of H_{L}_{₂} with respect to q is not affected by h^{L}^{₂}, since h^{L}^{₂} is a constant. These two observations complete our derivation of the QUBO matrix for the squared error term (r_{L}_{₂}), concluding that the matrix W^{L}^{₂}^{,2} is given by

W^{L}^{₂}=W^{L}^{₂}^{,1}+W^{L}^{₂}^{,2}. EQN. 32

The estimated cardinality of x under the fixed-point representation may be implemented via the binary vector q. Since we allow xᵢ to have negative values, we use the following strategy to facilitate the representations of the zero elements in x. Denote the combination of the binary elements that lead to xᵢ=0 by c_{i,p}⁰, satisfying

$$\begin{matrix}{x}_{i} = 0 = {c}_{i}^{min} + {d}_{i} {\sum }_{p = 1}^{P} {c}_{i , p}^{0} {2}^{( p - 1 )} , & {c}_{i , p}^{0} ∈ \{ 0 , 1 \} , & i = 1 , … , N .\end{matrix} \qquad EQN . 32$$

The binary elements c_{i,p}⁰ are known constants, which are derived from the predetermined constants cᵢ^{min}, dᵢ, and P. Given the constants c_{i,p}⁰, we define the “transformed spins”

$${y}_{i , p} = \{ \begin{matrix}1 - {q}_{i , p} , & {c}_{i , p}^{0} = 0 \\ {q}_{i , p} , & {c}_{i , p}^{0} = 1\end{matrix} \begin{matrix} \\ \end{matrix} . \qquad EQN . 33$$

Under the above formulation y_{i,p}=1 for all 1≤p≤P if and only if xᵢ=0. Compactly, this can be expressed as

zᵢ=y_{i,1},y_{i,2}, . . . ,y_{i,P}, EQN. 34

where zᵢ=1 if and only if xᵢ=0. Using zᵢ we can compute how many non-zeros we have in x by

$${H}_{{L}_{0}} = {\sum }_{i = 1}^{N} ( 1 - {z}_{i} ) . \qquad EQN . 35$$

Therefore, the formulation of the transformed spins y_{i,p} allows to express the cardinality penalty in QUBO terms, for the most general fixed-point representation. Unfortunately, in this general case, the variables zᵢ are not quadratic in the spins q_{i,p}. We overcome this challenge using auxiliary ancilla spins when needed, as will be described next.

In this simple setting, xᵢ=qᵢ by construction, as qᵢ is the binary spin that corresponds to the i^{th} entry in the binary x. Therefore, the number of non-zeros in the estimated x is simply the sum over all original spins, which can be written as

$${H}_{{L}_{0}}^{binary} = {‖ x ‖}_{0} = {\sum }_{i = 1}^{N} {q}_{i} = {\sum }_{i = 1}^{N} {q}_{i} {q}_{i} = {q}^{⊤} {W}^{{L}_{0}} q . \qquad EQN . 36$$

Above, the third equality holds since qᵢϵ [symbol] , and the fourth quality holds for the identity matrix W^{L}^{₀}=I of size N×N.

In contrast to the binary case, in the general setting of P>1, the cardinality of x is not equal anymore to the sum of the original spins q_{i,p}, 1≤p≤P, 1≤i≤N. Yet following the equation for H_{L}_{₀}, we can express the cardinality penalty using the transformed spins, y_{i,p}. For the case of P=2, y_{i,1} and y_{i,2} are predefined via the constants c_{i,p}⁰ϵ [symbol] , 1≤p≤2. The expression for H_{L}_{₀} is a quadratic function of the original spins q_{i,p}, and therefore, it can be written in the form q^{T} W^{L}^{₀}q. There are four optional spin combinations which yield four different W^{L}^{₀} matrices. They are summed in Table 1 (non-zero elements only).

TABLE 1

| C_{i,1}⁰ | C_{i,2}⁰ | y_{i,1} | y_{i,2} | (1 − zᵢ) | W^{L}^{₀} |
|---|---|---|---|---|---|
| 0 | 0 | 1 − q_{i,1} | 1 − q_{i,2} | q_{i,1} + q_{i,2} − q_{i,1}q_{i,2} | $\begin{matrix}{W}_{1 + 2 ( i - 1 ) , 1 + 2 ( i - 1 )}^{{L}_{0}} = \\ {W}_{2 + 2 ( i - 1 ) , 2 + 2 ( i - 1 )}^{{L}_{0}} = 1\end{matrix}$ |
| | | | | | $\begin{matrix}{W}_{1 + 2 ( i - 1 ) , 2 + 2 ( i - 1 )}^{{L}_{0}} = \\ {W}_{2 + 2 ( i - 1 ) , 1 + 2 ( i - 1 )}^{{L}_{0}} = - 1 / 2\end{matrix}$ |
| 0 | 1 | 1 − q_{i,1} | q_{i,2} | 1 − q_{i,2} + | W_{2+2(i-1),2+2(i-1)}^{L}^{₀} = −1 |
| | | | | q_{i,1}q_{i,2} | $\begin{matrix}{W}_{1 + 2 ( i - 1 ) , 2 + 2 ( i - 1 )}^{{L}_{0}} = \\ {W}_{2 + 2 ( i - 1 ) , 1 + 2 ( i - 1 )}^{{L}_{0}} = 1 / 2\end{matrix}$ |
| 1 | 0 | q_{i,1} | 1 − q_{i,2} | 1 − q_{i,1} + | W_{1+2(i-1),1+2(i-1)}^{L}^{₀} = −1 |
| | | | | q_{i,1}q_{i,2} | $\begin{matrix}{W}_{1 + 2 ( i - 1 ) , 2 + 2 ( i - 1 )}^{{L}_{0}} = \\ {W}_{2 + 2 ( i - 1 ) , 1 + 2 ( i - 1 )}^{{L}_{0}} = 1 / 2\end{matrix}$ |
| 1 | 1 | q_{i,1} | q_{i,2} | q_{i,1}q_{i,2} | $\begin{matrix}{W}_{1 + 2 ( i - 1 ) , 2 + 2 ( i - 1 )}^{{L}_{0}} = \\ {W}_{2 + 2 ( i - 1 ) , 1 + 2 ( i - 1 )}^{{L}_{0}} = 1 / 2\end{matrix}$ |

Note that the leading constant ‘1’ in the expressions for W^{L}^{₀} may be ignored since constants do not affect the solution of the underlying optimization problem. Moreover, we chose a symmetric matrix representation for the expressions of (1−zᵢ), however any matrix representation of the fourth column in the table is a valid QUBO representation.

The P-bit case would result in H_{L}_{₀} with high-order interactions between the original spins, breaking the bilinear structure of the QUBO problem. As a way out, we may introduce ancilla spins, which allow us to express H_{L}_{₀} for the most general representation of x in a quadratic form that perfectly fits the QUBO structure. Disclosed is a solution that is extremely efficient with respect to the number of ancilla spins: we add only one auxiliary spin per variable/feature, which we view as the minimal number of spins that one can hope for, in such a general case.

Turning to the details, denote the ancilla spin for xᵢ by sᵢϵ [symbol] and define the function

F(y_{i,1},y_{i,2}, . . . ,y_{i,P},sᵢ):=sᵢ·(y_{i,1}+y_{i,2}+ . . . y_{i,P}−(P−1)), EQN. 37

which gets as an input all the transformed spins y_{i,p} as well as the ancilla spin sᵢ associated with xᵢ. We use this function to express −zᵢ in the following way, which can be easily verified:

$$- {z}_{i} = - {y}_{i , 1} , {y}_{i , 2} … {y}_{i , P} = {min}_{{s}_{i}} ( - F ( {y}_{i , 1} , {y}_{i , 2} , … , {y}_{i , P} , {s}_{i} ) ) . \qquad EQN . 38$$

In plain words, the minimal value of the function −F(y_{i,1}, y_{i,2}, . . . , y_{i,P}, sᵢ), optimized with respect to the ancilla spin sᵢ, is in fact equal to −zᵢ. Since the function F is a sum of sᵢy_{i,p}, 1≤p≤P, we can harness it to form a cost function that is equivalent to those found above for H_{L}_{₀}, but involving only bilinear spin terms. Specifically, we define our cardinality Hamiltonian H_{L}_{₀} as

$${H}_{{L}_{0}} = {‖ x ‖}_{0} = {\sum }_{i = 1}^{N} ( 1 - {z}_{i} ) = {\sum }_{i = 1}^{N} ( 1 - F ( {y}_{i , 1} , {y}_{i , 2} , … , {y}_{i , P} , {s}_{i} ) ) = {\sum }_{i = 1}^{N} ( 1 - {s}_{i} {y}_{i , 1} - {s}_{i} {y}_{i , 2} - ⋯ - {s}_{i} {y}_{i , P} + {s}_{i} ( P - 1 ) ) . \qquad EQN . 39$$

In order to obtain the structure and content of the matrix W^{L}^{₀}, we must substitute in the spins q_{i,p}, as done for the P=2 case (e.g., in Table 1). By doing so, we obtain an expression that is quadratic with respect to the NP original spins q_{i,p}, as well as the additional N ancilla spins sᵢ. Concretely, we define the vector \tilde{q}=[q; s]^{T} that contains a total of N(P+1) spins; the first NP elements are the original spins q, and the rest are the N ancilla spins

s=[s₁,s₂, . . . ,s_{N}]. EQN. 40

Consequently, the matrix W^{L}^{₀} is of size N(P+1)×N(P+1), where we use the convention that the first NP rows (resp. columns) correspond to the spins q_{i,p} and the extra N rows (resp. columns) correspond to the ancilla spins sᵢ. Here, the QUBO problem defined with the vector of spins \tilde{q} is given by

$${\tilde{q}}^{T} ( {\tilde{W}}^{{L}_{2}} + λ {\tilde{W}}^{{L}_{0}} ) \tilde{q} , \qquad EQN . 41$$

where \tilde{W}^{L}^{₂} is a matrix of size N(P+1)×N(P+1), obtained by padding the matrix W^{L}^{₂} with zeros in all the entries that correspond to the ancilla spins, where W^{L}^{₂} is given as

W^{L}^{₂}=W^{L}^{₂}^{,1}+W^{L}^{₂}^{,2}. EQN. 42

Formulae, as used in the present invention, may be, or may be based on the above mathematics. Conversion formulae are also discussed elsewhere herein.

FIGS. 6 and 7 show a method for solving a sparse coding problem that may be carried out by a programmable optical coupler system, for example, as disclosed herein. FIG. 6 may disclose one part of the method, 600A, and FIG. 7 may disclose another part of the method. In some embodiments of the invention, both method parts (600A and 600B) are executed.

In operation 602, a first set of values for a measurement vector and a second set of values for a dictionary matrix may be received by a processor of a computing device. Each set of values may be based on an input. An input may come from, for example, a user and/or a computing device. The input may, in some embodiments, be based on information indicative of a physical system.

In operation 604, the measurement vector and the dictionary matrix may be converted into a quadratic unconstrained binary optimization (QUBO) matrix, by the processor, using at least one conversion formula (e.g., as detailed herein).

In operation 606, an input array of a plurality of laser beams may be emitted by a light beam source. Each laser beam has a phase and a magnitude/intensity.

In operation 608, each laser beam of the input array of laser beams may be split by a beam splitter to produce split laser beams.

In operation 610, values indicative of the QUBO matrix may be received by a phase alteration unit, from the computing device.

In operation 612, a phase of each laser beam of the split laser beams may be altered by the phase alteration unit, based on the QUBO matrix, to produce phase-altered split laser beams.

In operation 614, the phase-altered split laser beams may be combined into a combined output array of laser beams by a beam combiner. The combined output array of laser beams may be substantially perpendicular to the input array of laser beams.

In operation 616, the combined output array of laser beams may be detected by a light detector.

In operation 618, light magnitudes of each laser beam of the combined output array of laser beams may be minimized by a processor (e.g., a processor associated with the programmable optical coupler), as measured by the light detector, to obtain a minimizing input array of laser beams. This may be achieved by altering phase or magnitude of each laser beam of the input array of laser beams.

In operation 620, a phase and magnitude of each laser beam of the minimizing input array of laser beams may be output, by the processor (e.g., a processor associated with the programmable optical coupler), the output being or taking the form of a spin vector.

In operation 622, the spin vector may be converted into a solution vector, by the processor of the computing device, and using the at least one conversion formula. The solution vector may be indicative of a relationship between the values for a measurement vector and the values for a dictionary matrix. The at least one second conversion formula may be, or be related to, the inverse of the first conversion formula.

In some embodiments of the above method and programmable optical coupler system, the beam splitter may receive the input array of laser beams along a first axis and split each laser beam along a second axis, the beam combiner may combine the phase-altered split laser beams along the first axis to yield the combined output array of laser beams distributed along the second axis, and the first axis may be substantially perpendicular to the second axis.

In some embodiments of the above method and programmable optical coupler system, the programmable optical coupler may further comprise a control unit, configured to control the optical properties of at least one of: the beam splitter, the phase alteration unit, and the beam combiner. The control unit may be or include the processor of the programmable optical coupler.

In some embodiments of the above method and programmable optical coupler system, each of the beam splitter and beam combiner may comprise: a spatial light modulator; and at least one of: a lens and a diffractive optical element.

In some embodiments of the above method and programmable optical coupler system, the phase alteration unit may comprise a controllable spatial light modulator.

In some embodiments of the above method and programmable optical coupler system, the processor of the computing device may be the same as the processor of the programmable optical coupler. In some embodiments, the processor of the computing device may be different to and separate from the processor of the programmable optical coupler (though they may be linked or in communication). Any reference to a processor of the programmable optical coupler means that it may be preferable that said processor is associated with the programmable optical coupler, because it directly controls aspects of or interacts with the programmable optical coupler.

FIG. 8 may show a method for solving a sparse coding problem.

In operation 802, a first set of values for a measurement vector and a second set of values for a dictionary matrix may be received by a computing device. Each set of values may be based on an input. An input may come from, for example, a user and/or a computing device. The input may, in some embodiments, be based on information indicative of a physical system.

In operation 804, the measurement vector and the dictionary matrix may be converted by the computing device into a quadratic unconstrained binary optimization (QUBO) matrix, using at least one conversion formula (e.g., as detailed herein).

In operation 806, the QUBO matrix may be received at a suitable device. The suitability of the suitable device may relate to its ability to efficiently minimize a function of the QUBO matrix and a generalized spin vector. The suitable device may, in some embodiments, be an annealer. In some embodiments, the suitable device may be a quantum computer. In some embodiments, the suitable device may be a quantum annealer. In some embodiments of the invention, the suitable devices may not be classical computers, but rather devices that use sub-atomic phenomena, for example, atomic spins, phases of light, etc., to carry out calculations. Such non-classical devices (or computers) may be particularly suited to efficiently and quickly carrying out matrix multiplications (or similar). In some embodiments, heuristics may be used on classical computers to simulate non-classical computation (in this example, the suitable device may comprise a (classical) computing device).

In operation 808, the suitable device (e.g., annealer, quantum computer, etc.) may minimize a function of the QUBO matrix and a generalized spin vector, by altering states of device (e.g., states of the annealer, qubit states of the quantum computer, amplitude/intensity and phase of light in a programmable optical coupler, etc.), the states being indicative of values of the generalized spin vector. At the end of the minimization operation, a minimizing spin vector may be obtained. The minimizing spin vector may be an altered version of the generalized spin vector, wherein this altered version is the spin vector which provides a minimized function of the QUBO matrix and the spin vector. In other words, we may wish to find the argument of a minimization of a matrix vector multiplication function.

In operation 810, the minimizing spin vector may be output by the suitable device (e.g., annealer, quantum computer, etc.).

In operation 812, the spin vector may be converted into a solution vector using the at least one conversion formula, by the computing device (e.g., the computing device associated with operations 802 and 804). The solution vector may be indicative of a relationship between the values for a measurement vector and the values for a dictionary matrix.

With respect to each of the above systems and methods (e.g., FIGS. 6-8), data may be transferred between locations in between or during operations, if such a transfer of data is required. Data transfer may take any suitable form.

With respect to each of the above systems and methods (e.g., FIGS. 6-8), some or all of the following mathematics may be relevant, applicable, and/or used. The mathematics and formulae laid out below may be directly derived from the mathematics already derived elsewhere herein.

The sparse coding problem of FIGS. 6-8 may be given by

$$\hat{x} = arg {min}_{x} {‖ Ax - b ‖}_{2}^{2} + λ {‖ x ‖}_{0} \qquad EQN . 43$$

wherein \hat{x} represents a sparse solution to the sparse coding problem (e.g., the solution vector), x represents a generalized candidate solution to the sparse coding problem, A represents the dictionary matrix, b represents the measurement vector, and λ is a constant. In other words, one may seek to find the vector x which minimizes the expression ∥Ax−b∥₂²+λ∥x∥₀, given an input of A, b, and λ.

The function of the QUBO matrix and the generalized spin vector may be given by:

q^{T}Wq EQN. 44

wherein q represents the generalized spin vector, W represents the QUBO matrix, and q^{T} is the transpose of q. The function of the QUBO matrix and the generalized spin vector may be a “QUBO function”. In some embodiments of the invention, the generalized spin vector q may contain one or more ancilla spins.

The at least one conversion formula may be given by the following:

$$\begin{matrix}{x}_{i} = {c}_{i}^{min} + {d}_{i} {\sum }_{p = 1}^{P} {q}_{i p} {2}^{p - 1} , & P \geq 1 , & {q}_{i p} ∈ \{ 0 , 1 \} ,\end{matrix} \qquad EQN . 45$$

$$where :$$

$$\begin{matrix}{q}_{i p} = {q}_{i P + p} , & EQN . 46\end{matrix}$$

$$and$$

$$W = {W}^{{L}_{2}} + λ {W}^{{L}_{0}} . \qquad EQN . 47$$

The term W^{L}^{₂} may be found with the following additional part(s) of the at least one conversion formula:

$${W}^{{L}_{2}} = {W}^{{L}_{2} , 1} + {W}^{{L}_{2} , 2} , \qquad EQN . 48$$

$${W}_{s + P ( i - 1 ) , p + P ( j - 1 )}^{{L}_{2} , 1} := {2}^{s + p - 2} {W}_{i , j}^{b a s e , 1} {d}_{i} {d}_{j} , \qquad EQN . 49$$

$$1 \leq i , j \leq N , 1 \leq s , p \leq P ,$$

$${W}_{p + P ( i - 1 ) , p + P ( i - 1 )}^{{L}_{2} , 2} := {2}^{p - 1} {d}_{i} ( {W}_{i , i}^{b a s e , 2} + 2 {\sum }_{j = 1}^{N} {c}_{j}^{min} {W}_{i , j}^{b a s e , 1} ) , \qquad EQN . 50$$

$$1 \leq i \leq N , 1 \leq p \leq P ,$$

$${W}_{i , j}^{b a s e , 1} := {\sum }_{m = 1}^{M} {A}_{m , i} {A}_{m , j} , 1 \leq i , j \leq N , \qquad EQN . 51$$

$$and {W}_{i , i}^{b a s e , 2} := - 2 {\sum }_{m = 1}^{M} {A}_{m , i} {b}_{m} , 1 \leq i \leq N , \qquad EQN . 52$$

wherein matrices W^{L}^{₂}^{,1} and W^{L}^{₂}^{,2} above are of dimensions N(P+1)×N(P+1), entries of W^{L}^{₂}^{,1} and W^{L}^{₂}^{,2} are zero for entries not specified above, and P, N, M, cᵢ, and dᵢ are constants.

The term W^{L}^{₀} may be found with the following additional part(s) of the at least one conversion formula:

$${W}_{i + NP , i + N P}^{{L}_{0}} = 1 - {\sum }_{p = 1}^{P} {c}_{ip}^{0} , 1 \leq i \leq N , \qquad EQN . 53$$

$${W}_{i + NP , iP + p}^{{L}_{0}} = {W}_{i P + p , i + N P}^{{L}_{0}} = \frac{1 - 2 {c}_{i p}^{0}}{2} , 1 \leq i \leq N , 1 \leq p \leq P , \qquad EQN . 54$$

where the matrix W^{L}^{₀} has dimensions N(P+1)×N(P+1), and its entries are zero for entries which are not specified above, and cᵢₚ⁰ satisfy:

$${c}_{i}^{min} + {d}_{i} {\sum }_{p = 1}^{P} {c}_{i p}^{0} {2}^{p - 1} = 0 , \qquad EQN . 55$$

where and P, N, cᵢₚ⁰, cᵢ^{min}, and dᵢ are constants.

Other conversions or conversion formulae may be apparent to the person skilled in the art based on the formulae above and/or otherwise based on the mathematics disclosed herein. Such other conversions or conversion formulae may include, for example, amendments, alterations, rearrangements, or extensions of the mathematical formulae disclosed herein, and would fall within the spirit of the presently disclosed invention.

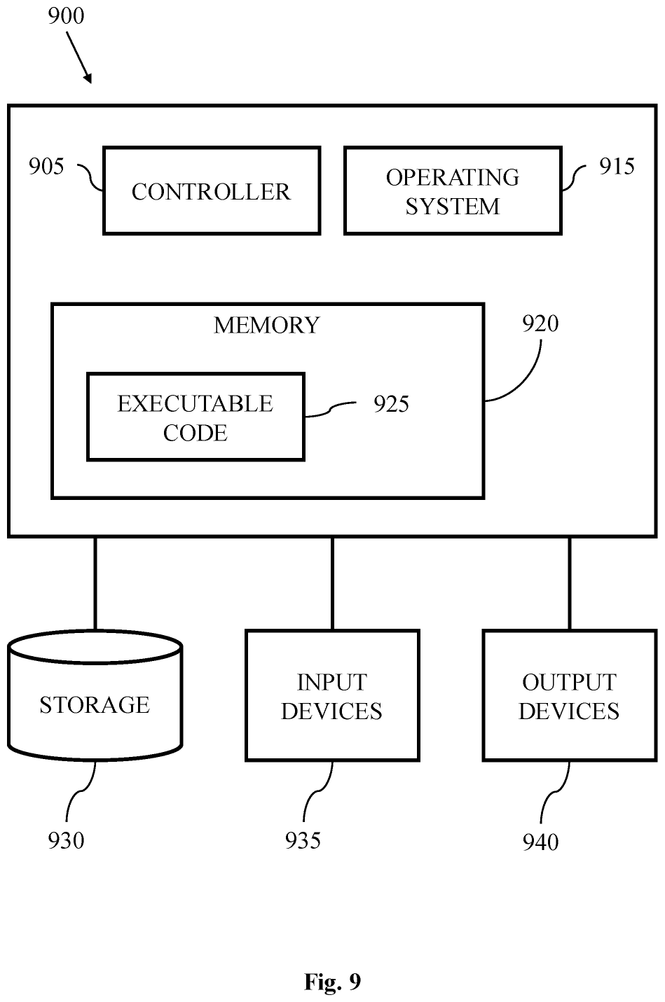

FIG. 9 shows a block diagram of an exemplary computing device which may be used with embodiments of the present invention. Computing device 500 may include a controller or computer processor 505 that may be, for example, a central processing unit processor (CPU), a chip or any suitable computing device, an operating system 515, a memory 520, a storage 530, input devices 535 and output devices 540 such as a computer display or monitor displaying for example a computer desktop system.

Operating system 515 may be or may include code to perform tasks involving coordination, scheduling, arbitration, or managing operation of computing device 500, for example, scheduling execution of programs. Memory 520 may be or may include, for example, a Random Access Memory (RAM), a read only memory (ROM), a Flash memory, a volatile or non-volatile memory, or other suitable memory units or storage units. At least a portion of Memory 520 may include data storage housed online on the cloud. Memory 520 may be or may include a plurality of different memory units. Memory 520 may store, for example, instructions (e.g., code 525) to carry out methods as disclosed herein, for example, embodiments of method steps/operations of FIGS. 5-8. Memory 520 may use a datastore, such as a database.

Executable code 525 may be any application, program, process, task, or script. Executable code 525 may be executed by controller 505, possibly under control of operating system 515. For example, executable code 525 may be, or may execute, one or more applications performing methods as disclosed herein, such as converting matrices of data into a QUBO representation. In some embodiments, more than one computing device 500 or components of device 500 may be used. One or more processor(s) 505 may be configured to carry out embodiments of the present invention by, for example, executing software or code.

Storage 530 may be or may include, for example, a hard disk drive, a solid-state drive, a compact disk (CD) drive, a universal serial bus (USB) device or other suitable removable and/or fixed storage unit. Data described herein may be stored in a storage 530 and may be loaded from storage 530 into a memory 520 where it may be processed by controller 505. Storage 530 may include cloud storage.

Input devices 535 may be or may include a mouse, a keyboard, a touch screen or pad or any suitable input device or combination of devices. Output devices 540 may include one or more displays, speakers, virtual reality headsets, and/or any other suitable output devices or combination of output devices. Any applicable input/output (I/O) devices may be connected to computing device 500, for example, a wired or wireless network interface card (NIC), a modem, printer, a universal serial bus (USB) device or external hard drive may be included in input devices 535 and/or output devices 540.

Embodiments of the invention may include one or more article(s) (e.g., memory 520 or storage 530) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

Computing device 500 may additionally comprise a communication unit for communicating, transferring, transmitting, and/or receiving data to, from, or between another computing device (e.g., one similar to device 500).

Systems and methods of the present invention may improve existing optical coupler and sparse coding problem solving technology. Optical coupler technology may be improved by the provision of a versatile, efficient, and rapid optical coupler (annealer) that may be programmed. Sparse coding optimization technology may be improved by the provision of methods for converting a sparse coding optimization problem into a quadratic unconstrained binary optimization for minimization by an annealer (such as a programmable optical coupler), a quantum computer, or similar apparatus. In combination, the programmable optical coupler may solve sparse coding optimization problems particularly quickly and efficiently.

Systems and methods of the present invention may be applied to problems in the fields of machine learning, statistics, signal processing, biological sciences etc. For example, in genome-wide association studies (GWAS), scientists may be interested in identifying which portions of genetic code (e.g., single-nucleotide polymorphisms (SNPs)) (which may be encoded as a dictionary matrix) may be associated with some phenotype (e.g., blood type, cancer risk, etc.) (which may be encoded as a measurement vector). Embodiments of the present invention may be used to identify a sparse set of important SNPs that may contribute to a certain phenotype, in order to, for example, improve medical treatments or apparatuses. The number of SNPs may be very large, when compared to the important SNPs which correlate to the phenotype, and as such, it is in this sense that the set of important SNPs may be said to be sparse.

Different embodiments are disclosed herein. Features of certain embodiments may be combined with features of other embodiments; thus, certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A programmable optical coupler system for solving a sparse coding problem, the programmable optical coupler system comprising:
a computing device, the computing device comprising:
a processor, the processor configured to:
receive a first set of values for a measurement vector and a second set of values for a dictionary matrix, based on an input;
convert, using at least one conversion formula, the measurement vector and the dictionary matrix into a quadratic unconstrained binary optimization (QUBO) matrix;
a programmable optical coupler, the programmable optical coupler comprising:
a light beam source to emit an input array of a plurality of laser beams, wherein each laser beam has a phase and a magnitude;
a beam splitter, to split each laser beam of the input array of laser beams, to produce split laser beams;
a phase alteration unit to receive values indicative of the QUBO matrix from the computing device, and to alter a phase of each laser beam of the split laser beams based on the QUBO matrix, to produce phase-altered split laser beams; and
a beam combiner to combine the phase-altered split laser beams into a combined output array of laser beams, the combined output array of laser beams being substantially perpendicular to the input array of laser beams;
a light detector to detect the combined output array of laser beams; and
a processor, the processor configured to:
minimize light magnitudes of each laser beam of the combined output array of laser beams as measured by the light detector, by altering phase or magnitude of each laser beam of the input array of laser beams, to obtain a minimizing input array of laser beams; and
output a phase and magnitude of each laser beam of the minimizing input array of laser beams as a spin vector;
wherein the processor of the computing device is further configured to:
convert using the at least one conversion formula, the spin vector into a solution vector, wherein the solution vector is indicative of a relationship between the values for a measurement vector and the values for a dictionary matrix.

2. The programmable optical coupler system of claim 1, wherein:
the beam splitter is to receive the input array of laser beams along a first axis and split each laser beam along a second axis;
the beam combiner is to combine the phase-altered split laser beams along the first axis to yield the combined output array of laser beams distributed along the second axis;
wherein the first axis is substantially perpendicular to the second axis.

3. The programmable optical coupler system of claim 1, wherein the programmable optical coupler further comprises a control unit, configured to control the optical properties of at least one of: the beam splitter, the phase alteration unit, and the beam combiner.

4. The programmable optical coupler system of claim 1, wherein each of the beam splitter and beam combiner comprise: a spatial light modulator; and at least one of: a lens and a diffractive optical element

5. The programmable optical coupler system of claim 1, wherein the phase alteration unit comprises a controllable spatial light modulator.

6. The programmable optical coupler of claim 1 wherein, the sparse coding problem is given by:
$$\hat{x} = arg {min}_{x} {‖ Ax - b ‖}_{2}^{2} + λ {‖ x ‖}_{0}$$
wherein \hat{x} represents a sparse solution to the sparse coding problem, x represents a candidate solution to the sparse coding problem, A represents the dictionary matrix, b represents the measurement vector, and λ is a constant.

7. The method of claim 6, wherein the function of the QUBO matrix and the generalized spin vector is given by:
q^{T}Wq
wherein q represents the generalized spin vector and W represents the QUBO matrix.

8. The method of claim 7, wherein the at least one conversion formula is given by:
$${x}_{i} = {c}_{i}^{min} + {d}_{i} {\sum }_{p = 1}^{P} {q}_{i p} {2}^{p - 1} , P \geq 1 , {q}_{i p} ∈ \{ 0 , 1 \} , 1 \leq i \leq N ,$$
$$where : {q}_{i p} = {q}_{i P + p}$$
$$and W = {W}^{{L}_{2}} + λ {W}^{{L}_{0}} ,$$
$$where : {W}^{{L}_{2}} = {W}^{{L}_{2} , 1} + {W}^{{L}_{2} , 2}$$
$${W}_{s + P ( i - 1 ) , p + P ( j - 1 )}^{{L}_{2} , 1} := {2}^{s + p - 2} {W}_{i , j}^{b a s e , 1} {d}_{i} {d}_{j} ,$$
$$1 \leq i , j \leq N , 1 \leq s , p \leq P ,$$
$${W}_{p + P ( i - 1 ) , p + P ( i - 1 )}^{{L}_{2} , 2} := {2}^{p - 1} {d}_{i} ( {W}_{i , i}^{b a s e , 2} + 2 {\sum }_{j = 1}^{N} {c}_{j}^{min} {W}_{i , j}^{b a s e , 1} ) ,$$
$$1 \leq i \leq N , 1 \leq p \leq P ,$$
$${W}_{i , j}^{b a s e , 1} := {\sum }_{m = 1}^{M} {A}_{m , i} {A}_{m , j} , 1 \leq i , j \leq N ,$$
$$and {W}_{i , i}^{b a s e , 2} := - 2 {\sum }_{m = 1}^{M} {A}_{m , i} {b}_{m} , 1 \leq i \leq N ,$$
wherein matrices W^{L}^{₂}^{,1} and W^{L}^{₂}^{,2} above are of dimensions N(P+1)×N(P+1), entries of W^{L}^{₂}^{,1} and W^{L}^{₂}^{,2} are zero for entries not specified above, and P, N, M, cᵢ, and dᵢ are constants; and
$${W}_{i + NP , i + N P}^{{L}_{0}} = 1 - {\sum }_{p = 1}^{P} {c}_{ip}^{0} , 1 \leq i \leq N , P \geq 1$$
$${W}_{i + NP , iP + p}^{{L}_{0}} = {W}_{i P + p , i + N P}^{{L}_{0}} = \frac{1 - 2 {c}_{i p}^{0}}{2} , 1 \leq i \leq N , 1 \leq p \leq P$$
where the matrix W^{L}^{₀} has dimensions N(P+1)×N(P+1), and its entries are zero for entries which are not specified above, and cᵢₚ⁰ satisfy:
$${c}_{i}^{min} + {d}_{i} {\sum }_{p = 1}^{P} {c}_{i p}^{0} {2}^{p - 1} = 0 ,$$
and P, N, cᵢₚ⁰, cᵢ^{min}, and dᵢ are constants.

9. An annealer or quantum computer system for solving a sparse coding problem, the system comprising:
a computing device, the computing device comprising:
a processor, the processor configured to:
receive a first set of values for a measurement vector and a second set of values for a dictionary matrix, based on an input;
convert, using at least one conversion formula, the measurement vector and the dictionary matrix into a quadratic unconstrained binary optimization (QUBO) matrix;
an annealer or quantum computer to:
receive, from the computing device, the QUBO matrix; and
minimize a function of the QUBO matrix and a generalized spin vector, by altering states of the annealer or quantum computer, the states being indicative of values of the generalized spin vector, to obtain a minimizing spin vector; and
output the minimizing spin vector;
wherein the processor of the computing device is further configured to:
convert using the at least one conversion formula, the spin vector into a solution vector, wherein the solution vector is indicative of a relationship between the values for a measurement vector and the values for a dictionary matrix.

10. The system of claim 9, wherein the annealer comprises an optical annealer.

11. The system of claim 9, wherein, the sparse coding problem is given by:
$$\hat{x} = arg {min}_{x} {‖ Ax - b ‖}_{2}^{2} + λ {‖ x ‖}_{0}$$
wherein \hat{x} represents a sparse solution to the sparse coding problem, x represents a candidate solution to the sparse coding problem, A represents the dictionary matrix, b represents the measurement vector, and λ is a constant.

12. The method of claim 11, wherein the function of the QUBO matrix and the generalized spin vector is given by:
q^{T}Wq
wherein q represents the generalized spin vector and W represents the QUBO matrix.

13. The method of claim 12, wherein the at least one conversion formula is given by:
$${x}_{i} = {c}_{i}^{min} + {d}_{i} {\sum }_{p = 1}^{P} {q}_{i p} {2}^{p - 1} , P \geq 1 , {q}_{i p} ∈ \{ 0 , 1 \} , 1 \leq i \leq N ,$$
$$where : {q}_{i p} = {q}_{i P + p}$$
$$and W = {W}^{{L}_{2}} + λ {W}^{{L}_{0}} ,$$
$$where : {W}^{{L}_{2}} = {W}^{{L}_{2} , 1} + {W}^{{L}_{2} , 2}$$
$${W}_{s + P ( i - 1 ) , p + P ( j - 1 )}^{{L}_{2} , 1} := {2}^{s + p - 2} {W}_{i , j}^{b a s e , 1} {d}_{i} {d}_{j} ,$$
$$1 \leq i , j \leq N , 1 \leq s , p \leq P ,$$
$${W}_{p + P ( i - 1 ) , p + P ( i - 1 )}^{{L}_{2} , 2} := {2}^{p - 1} {d}_{i} ( {W}_{i , i}^{b a s e , 2} + 2 {\sum }_{j = 1}^{N} {c}_{j}^{min} {W}_{i , j}^{b a s e , 1} ) ,$$
$$1 \leq i \leq N , 1 \leq p \leq P ,$$
$${W}_{i , j}^{b a s e , 1} := {\sum }_{m = 1}^{M} {A}_{m , i} {A}_{m , j} , 1 \leq i , j \leq N ,$$
$$and {W}_{i , i}^{b a s e , 2} := - 2 {\sum }_{m = 1}^{M} {A}_{m , i} {b}_{m} , 1 \leq i \leq N ,$$
wherein matrices W^{L}^{₂}^{,1} and W^{L}^{₂}^{,2} above are of dimensions N(P+1)×N(P+1), entries of W^{L}^{₂}^{,1} and W^{L}^{₂}^{,2} are zero for entries not specified above, and P, N, M, cᵢ, and dᵢ are constants.

14. The method of claim 13, wherein
$${W}_{i + NP , i + N P}^{{L}_{0}} = 1 - {\sum }_{p = 1}^{P} {c}_{ip}^{0} , 1 \leq i \leq N , P \geq 1$$
$${W}_{i + NP , iP + p}^{{L}_{0}} = {W}_{i P + p , i + N P}^{{L}_{0}} = \frac{1 - 2 {c}_{i p}^{0}}{2} , 1 \leq i \leq N , 1 \leq p \leq P$$
where the matrix W^{L}^{₀} has dimensions N(P+1)×N(P+1), and its entries are zero for entries which are not specified above, and cᵢₚ⁰ satisfy:
$${c}_{i}^{min} + {d}_{i} {\sum }_{p = 1}^{P} {c}_{i p}^{0} {2}^{p - 1} = 0 ,$$
and P, N, cᵢₚ⁰, cᵢ^{min}, and dᵢ are constants.

15. A method for solving a sparse coding problem, the method comprising:
receiving, by a computing device, a first set of values for a measurement vector and a second set of values for a dictionary matrix, based on an input;
converting, by the computing device, the measurement vector and the dictionary matrix into a quadratic unconstrained binary optimization (QUBO) matrix, using at least one conversion formula;
receiving the QUBO matrix at an annealer or quantum computer;
minimizing, by the annealer or quantum computer, a function of the QUBO matrix and a generalized spin vector, by altering states of the annealer or quantum computer, the states being indicative of values of the generalized spin vector, to obtain a minimizing spin vector;
outputting, by the annealer or quantum computer, the minimizing spin vector; and
converting, by the computing device, the spin vector into a solution vector using the at least one conversion formula, wherein the solution vector is indicative of a relationship between the values for a measurement vector and the values for a dictionary matrix.

16. The method of claim 15 wherein, the sparse coding problem is given by:
$$\hat{x} = arg {min}_{x} {‖ Ax - b ‖}_{2}^{2} + λ {‖ x ‖}_{0}$$
wherein \hat{x} represents a sparse solution to the sparse coding problem, x represents a candidate solution to the sparse coding problem, A represents the dictionary matrix, b represents the measurement vector, and λ is a constant.

17. The method of claim 16, wherein the function of the QUBO matrix and the generalized spin vector is given by:
q^{T}Wq
wherein q represents the generalized spin vector and W represents the QUBO matrix.

18. The method of claim 17, wherein the generalized spin vector q contains ancilla spins.

19. The method of claim 19, wherein the at least one conversion formula is given by:
$${x}_{i} = {c}_{i}^{min} + {d}_{i} {\sum }_{p = 1}^{P} {q}_{i p} {2}^{p - 1} , P \geq 1 , {q}_{i p} ∈ \{ 0 , 1 \} , 1 \leq i \leq N ,$$
$$where : {q}_{i p} = {q}_{i P + p}$$
$$and W = {W}^{{L}_{2}} + λ {W}^{{L}_{0}} ,$$
$$where : {W}^{{L}_{2}} = {W}^{{L}_{2} , 1} + {W}^{{L}_{2} , 2}$$
$${W}_{s + P ( i - 1 ) , p + P ( j - 1 )}^{{L}_{2} , 1} := {2}^{s + p - 2} {W}_{i , j}^{b a s e , 1} {d}_{i} {d}_{j} ,$$
$$1 \leq i , j \leq N , 1 \leq s , p \leq P ,$$
$${W}_{p + P ( i - 1 ) , p + P ( i - 1 )}^{{L}_{2} , 2} := {2}^{p - 1} {d}_{i} ( {W}_{i , i}^{b a s e , 2} + 2 {\sum }_{j = 1}^{N} {c}_{j}^{min} {W}_{i , j}^{b a s e , 1} ) ,$$
$$1 \leq i \leq N , 1 \leq p \leq P ,$$
$${W}_{i , j}^{b a s e , 1} := {\sum }_{m = 1}^{M} {A}_{m , i} {A}_{m , j} , 1 \leq i , j \leq N ,$$
$$and {W}_{i , i}^{b a s e , 2} := - 2 {\sum }_{m = 1}^{M} {A}_{m , i} {b}_{m} , 1 \leq i \leq N ,$$
wherein matrices W^{L}^{₂}^{,1} and W^{L}^{₂}^{,2} above are of dimensions N(P+1)×N(P+1), entries of W^{L}^{₂}^{,1} and W^{L}^{₂}^{,2} are zero for entries not specified above, and P, N, M, cᵢ, and dᵢ are constants.

20. The method of claim 19, wherein
$${W}_{i + NP , i + N P}^{{L}_{0}} = 1 - {\sum }_{p = 1}^{P} {c}_{ip}^{0} , 1 \leq i \leq N , P \geq 1$$
$${W}_{i + NP , iP + p}^{{L}_{0}} = {W}_{i P + p , i + N P}^{{L}_{0}} = \frac{1 - 2 {c}_{i p}^{0}}{2} , 1 \leq i \leq N , 1 \leq p \leq P$$
where the matrix W^{L}^{₀} has dimensions N(P+1)×N(P+1), and its entries are zero for entries which are not specified above, and cᵢₚ⁰ satisfy:
$${c}_{i}^{min} + {d}_{i} {\sum }_{p = 1}^{P} {c}_{i p}^{0} {2}^{p - 1} = 0 ,$$
and P, N, cᵢₚ⁰, cᵢ^{min}, and dᵢ are constants.
